(19) United States
(12) Patent Application Publication
(10) Pub. No.: US 2006/0028716 A1
(43) Pub. Date: Feb. 9, 2006

(54) Corrected microscope and method for correcting the xyz drift caused by temperature change

(76) Inventor: Manfred Gilbert, Schoffengrund (DE)

Correspondence Address: SIMPSON & SIMPSON, PLLC, 5555 MAIN STREET, WILLIAMSVILLE, NY, 14221-5406, US

(21) Appl. No.: 10/529,987

(22) PCT Filed: Oct. 1, 2003
(86) PCT No.: PCT/EP03/50675

§ 371 Date: Mar. 31, 2005

(30) Foreign Application Priority Data
Oct. 2, 2002 (DE) 102 46 274.7

(51) Int. Cl. G02B 21/00

(52) U.S. Cl. 359/368; 359/391

(57) ABSTRACT

The present invention discloses a microscope (2) having a stand (12) and a microscope stage (18) which is arranged on the stand (12) and which can be adjusted by at least one motor in all three spatial directions. As least one temperature sensor (30) and a command/control unit (10) are provided. The command/control unit (10) comprises a memory (9) and a microprocessor (11). A correction table (44) is stored in the memory, containing drift values for the three spatial directions (X, Y, and Z) as a function of temperature.

### FIELD OF THE INVENTION

The invention relates to a microscope corrected for the XYZ drift caused by temperature change. In particular, the microscope comprises a stand, a microscope stage mounted on the stand and capable of being moved in all three space directions by means of motors and at least one temperature sensor.

The invention also relates to a method for correcting the XYZ drift caused by temperature change. In particular, the method is used in conjunction with a microscope comprising a stand, a microscope stage mounted on the stand and capable of being moved in all three space directions by means of motors and at least one temperature sensor.

### BACKGROUND OF THE INVENTION

German Unexamined Patent Application DE 199 59 228 discloses a laser scanning microscope comprising a temperature sensor the signals of which are used for focus correction by means of stored reference values. The temperature change measured is converted into a corresponding adjustment to be carried out by at-least one microscope component (stage movement, piezo setting, mirror distortion, etc). The temperature compensation can also take place with the aid of a stored table or curve. This method can keep constant only the Z-coordinate, namely the focus. Such a method does not compensate for an excursion of the specimen within the XY plane defined by the stage surface.

German Patent DE 195 301 36 C1 also describes a microscope with focus stabilization. A device for focus stabilization in a microscope is disclosed in this case. The temperature stabilization is accomplished by means of two metal rods having different thermal expansion coefficients. One rod is connected with the gear rack for focus adjustment and the other is connected with the microscope stage. Focus stabilization occurs exclusively by mechanical means individually adapted to the microscope.

Japanese patent application (JP 03 102 752) discloses a method for controlling the microscope stage. In this, case the temperature dependence of an element of the microscope stage is determined. The calculated drift of a few elements is used to correct the position of the specimen for the calculated drift. It may be possible to see from FIG. 2 of the “PATENT ABSTRACTS OF JAPAN” that the correction of the stage position occurs in the X- and Y-direction. The abstract makes no mention of temperature sensors.

### BRIEF SUMMARY OF THE INVENTION

The object of the invention is to provide a microscope capable of keeping stable the examination conditions set by the operator. To this end, the microscope must be configured in a manner such that the XYZ position of a specimen to be examined is kept constant.

This objective is reached by means of a microscope having the features described in claim 1.

Another object of the invention is to provide a method that will keep the examination conditions set by the operator stable. To this end, the microscope must be configured in a manner such that the XYZ position of a specimen to be examined is kept constant.

This objective is reached by a method for correcting the XYZ drift caused by temperature change, said method comprising the features of claim 8.

The invention has the advantage that the microscope is not sensitive to temperature changes and that said microscope keeps constant relative to the optical axis not only the focus position but also the object position. The invention is particularly advantageous for long-term examinations. In this regard, it is particularly important that the specimen to be examined remain constant in its position relative to the objective in its work position. In this regard, the temperature changes causing thermal expansion of the stand and thus an XYZ drift of the specimen have no effect, and the specimen is constant in all space directions relative to the optical axis of the objective. The microscope has a stand and disposed on the stand a microscope stage adjustable in all three space directions by means of motors. Moreover, at least one temperature sensor is provided on or in the microscope stand or in the immediate vicinity of the microscope. A regulating and control unit comprises a data storage device and a microprocessor, with a correction table stored in the data storage device, said correction table containing the drift values for all three space directions as a function of temperature, the temperature sensors providing the microprocessor with signals on the basis of which appropriate values can be called up for the purpose of keeping the specimen in the work position of the microscope objective. The correction table can be established manually or automatically.

The method for correcting the XYZ drift in a microscope induced by temperature change can be described as follows. At first, a correction table has to be recorded and stored in a data storage device in a regulating and control unit associated with the microscope. The microscope is operated in the examination mode so that the regulating and control unit, based on the signals from the temperature sensors and the content of the correction table, regulates the first, second and third motor in a manner such that the position of the specimen remains constant with time relative to the optical axis of the objective in the work position. When the correction table is established manually, then a first cross hairs is provided in the ocular and a second one on the slide. The slide is placed on the microscope stage, and a person brings the second cross hairs into focus by means of the third motor, the superposition between the first and the second cross hairs subsequently being achieved by an appropriate setting of the first and/or second motor. By actuating an input means, the microprocessor of the regulating and control unit transmits the data needed for the adjustment to the correction table stored in the data storage device. This procedure is repeated until there are no further temperature-induced changes.

When the correction table is established automatically, only the second cross hairs on the slide that is placed on the microscope stage is used. After the microscope is turned on, a camera is focused on the second cross hairs by means of an autofocus of the camera. The second cross hairs is shifted into the optical axis of the objective in the work position by use of an image-processing software in cooperation with the first and the second motor. The data needed for the shift are transferred to the correction table stored in the data storage device. This procedure is repeated until there are no further temperature-induced changes.

Other advantageous embodiments of the invention are covered in the subclaims.

### BRIEF DESCRIPTION OF THE DRAWINGS

In the drawings, the subject matter of the invention is represented schematically and will now be described in the following with reference to the figures. The drawings show the following:

FIG. 1 is a schematic view of a first exemplary embodiment of the microscope with XYZ drift compensation;

FIG. 2 is a schematic view of a second exemplary embodiment of the microscope with XYZ drift compensation;

FIG. 3a is a schematic representation of the deviation of the optical means for determining the XYZ drift for the purpose of creating a correction table;

FIG. 3b is a schematic representation showing the superposition of the optical means for determining the XYZ drift for the purpose of creating a correction table;

FIG. 4 is a correction table according to the present invention;

FIG. 5 is a schematic representation of the hardware for correcting XYZ drift caused by temperature changes; and

FIG. 6 shows in principle the structure of the software for correcting XYZ drift caused by temperature changes.

### DETAILED DESCRIPTION OF THE INVENTION

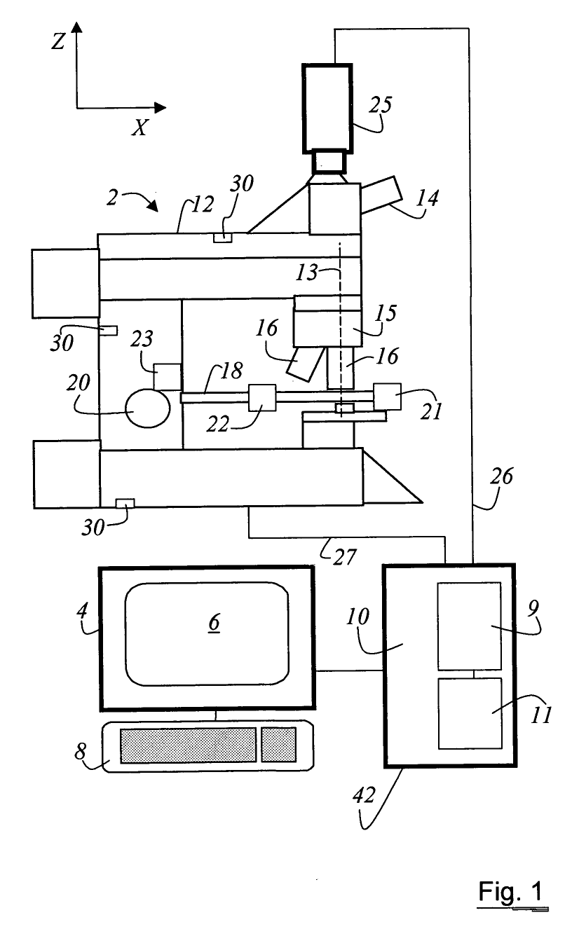

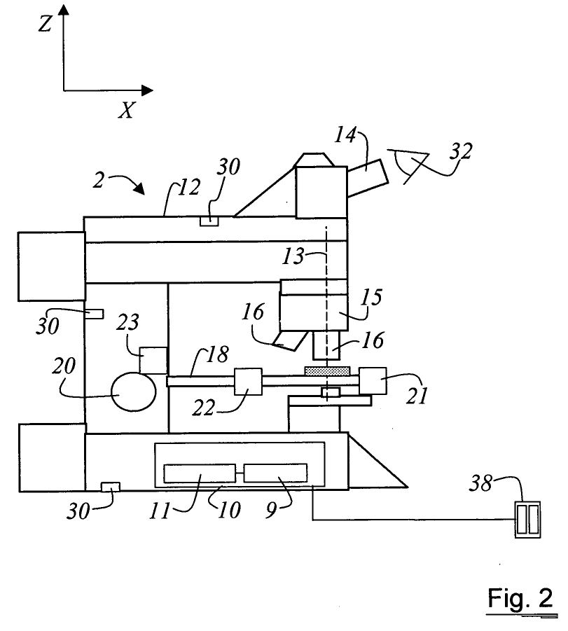

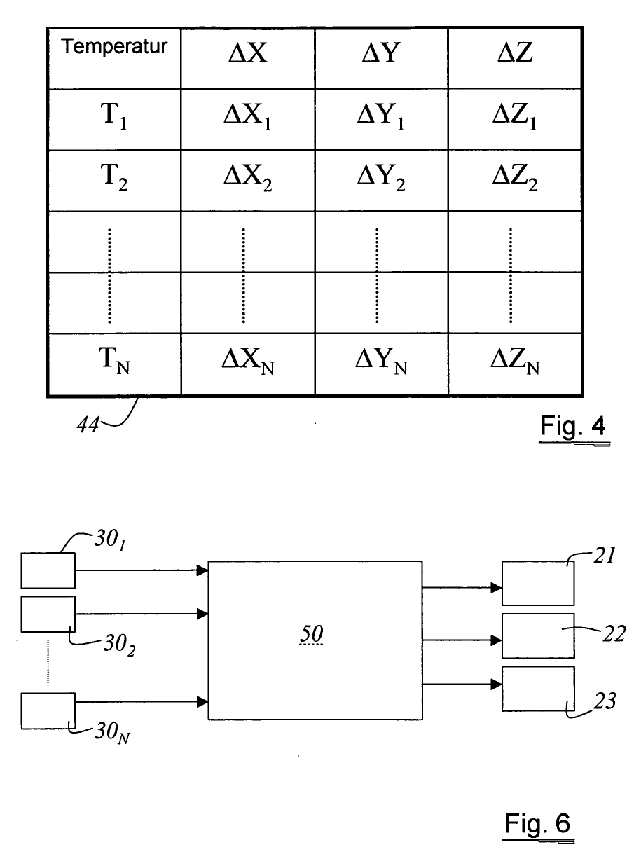

FIG. 1 shows schematically a side view of a microscope 2. In the exemplary embodiment shown here, microscope 2 is associated with a computer 4 having a display 6 and an input device 8 and with a regulation and control unit 10 for regulating the various microscope functions. The regulating and control unit 10 also comprises a data storage device 9 and a microprocessor 11. Naturally, microscope 2 can have any conceivable shape and configuration so that the representation in FIG. 1 should not be viewed as a limitation. Microscope 2 comprises a stand 12 on which there is provided at least one ocular 14, at least one objective 16 and one microscope stage 18 adjustable in all three space directions. A specimen 40 to be examined or treated microscopically can be placed on microscope stage 18 (see FIG. 2). In FIG. 1 and FIG. 2, the X-direction is indicated by X and the Z-direction by Z. In these representations, the Y-direction is perpendicular to the plane of the drawing. In the exemplary embodiment shown here, the microscope comprises a turret 15 to which are attached several objectives 16. At least one objective 16 is disposed in the work position and defines an optical axis 13 (indicated by the broken line). Moreover, on each side of stand 12 there is provided an adjusting knob 20 with which the height of microscope stage 18 can be adjusted (in the Z-direction) relative to objective 16 in the work position. Microscope stage 18 of microscope 2 can be adjusted in the X-direction with a first motor 21, in the Y-direction with a second motor 22 and in the Z-direction with a third motor 23. The first, second and third motor 21, 22 and 23 are operated via the regulating and control unit 10. Connected with microscope 2 is a camera 25 which records the image of the object observed with objective 16. Camera 25 is connected with the regulating and control unit 10 by a first electric connection 26. Regulating and control unit 10 is also connected with microscope 2 via a second electric connection 27 by which the signals from microscope 2 are transmitted to the regulating and control unit and the signals from the regulating and control unit are transmitted to microscope 2. In or on microscope 2 there is provided at least one temperature sensor 30 from which the signals are transmitted via the second electric connection 27 to regulating and control unit 10 and there guided to microprocessor 11 or data storage device 9. Naturally, camera 25 is either a video camera or a CCD camera. During operation in a certain mode, the data provided by camera 25 and computed by microprocessor 11 are entered into a correction table stored in data storage device 9 (see FIG. 4). The correction table contains the drift values for the three space directions X, Y and Z as a function of temperature. In the exemplary embodiment represented in FIG. 1, the regulating and control unit 10 is contained in an external electronics box 42 connected with microscope 2.

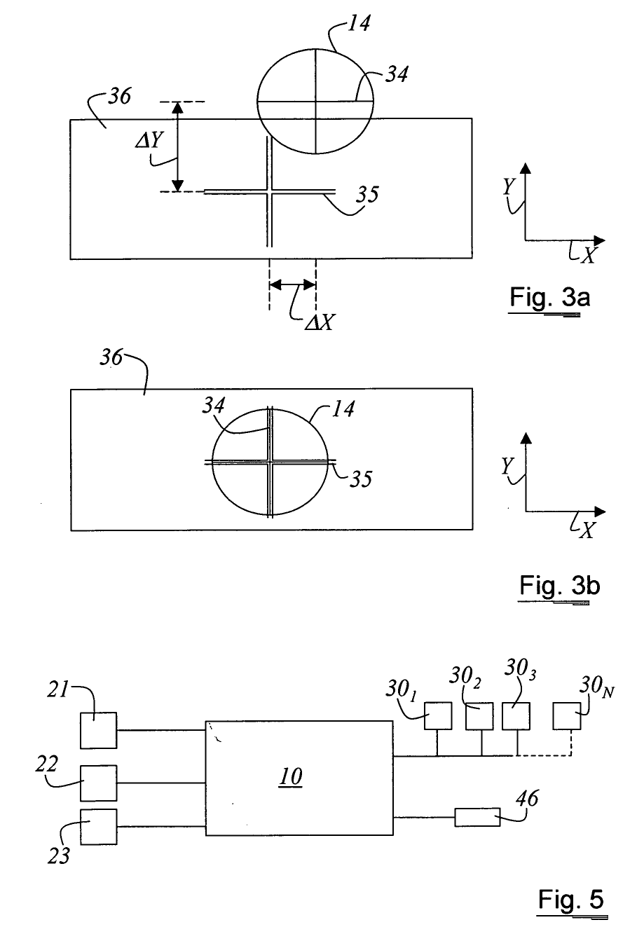

FIG. 2 shows a schematic view of a second exemplary embodiment of microscope 2 with XYZ drift compensation. Elements identical to those of FIG. 1 are referred to by identical reference numerals. The exemplary embodiment of FIG. 2 differs from that of FIG. 1, however, in that the correction table is obtained manually by a person 32. Person 32 can be, for example, a user of the microscope. Person 32 can also be the personnel assembling microscope 2 in the factory. After the microscope is turned on, person 32 establishes the correction table. To this end, as shown in FIG. 3a or FIG. 3b, a first cross hairs 34 is provided in ocular 14. Moreover, a second cross hairs 35 is provided on slide 36 which is placed on microscope stage 18 for the purpose of determining the correction table. At certain time intervals, person 32 brings cross hairs 35 into focus and then superposes first cross hairs 34 in the ocular onto second cross hairs 35. The focusing and superposing are brought about by an appropriate displacement with the first, second and third motor 21, 22, 23. By actuating an input device 38, microprocessor 11 transmits the data needed for the displacement to the correction table provided in the data storage device 9. This is done by person 32 at several time intervals. In the exemplary em-bodiment shown in FIG. 2, the data storage device 9 and microprocessor 11 in the control unit are provided in stand 12 of microscope 2. Input device 38 is connected with regulating and control unit 10.

FIG. 3a shows a schematic representation of the deviation of the optical means in determining the XYZ drift for the purpose of creating a correction table. The optical means comprise the first cross hairs 34 disposed in ocular 14. Moreover, slide 36 with the second cross hairs 36 is placed onto microscope stage 18 (not shown in FIG. 3a). In the representation of FIG. 3a, the Z-direction is perpendicular to the plane of the drawing. The first and the second cross hairs are not superposed. Between the first and second cross hairs 34, 35, a deviation ΔX exists in the X-direction and a deviation ΔY in the Y-direction.

FIG. 3b shows the situation wherein first cross hairs 34 in ocular 14 has been brought into superposition with the second cross hairs 35 on slide 36. The second cross hairs 35 must also be brought into focus. The extent of the displacement is recorded and, for example, entered into a data storage device. In the manual method described in FIG. 2, the ΔX, ΔY and ΔZ values are entered into regulating and control unit 10, for example, by pressing the input key. The ΔX and ΔY values correspond to the length to which microscope stage 18 had to be displaced in the X-direction and Y-direction to bring the first and second cross hairs into superposition. The ΔZ value corresponds to the length to which microscope stage 18 or objective 16 had to be moved relative to each other in the direction of optical axis 13 to bring about correct focusing. This procedure is repeated until microscope 2 is in a thermally stable condition. The values obtained are transmitted via an interface to the hardware disposed in microscope 2 (regulating and control unit 10) and there entered into the data storage device 9. Data storage takes place whenever the user presses the input key 38 thus confirming that the focus is stable and that the first and second cross hairs 34 and 35 are superposed.

In the case of automatic determination of the correction values, slide 36 with the second cross hairs 35 is required only in the plane of the preparation on microscope stage 18. After turning on the microscope, the second cross hairs 35 in the plane of the preparation is focused by means of an autofocus in camera 25 (see FIG. 1) and, by an image-processing software especially provided for this purpose, is brought into a calibration position (preferably the middle of the visual field, namely the optical axis 13 of objective 16 in the work position). At freely selected time intervals, this software repeats the above-described functions (autofocus, image center) and stores the XYZ drift values until no further change in the XYZ positions can be measured and the thermally stable condition has thus been reached. As for the manual establishment of the temperature values, these values are now transmitted to the hardware (regulating and control unit 10) disposed in the microscope or in an external electronics box 42 where they are stored.

FIG. 4 shows a correction table 44 according to the present invention. The number of rows in correction table 44 changes depending on the number of measurements of the correction values.

FIG. 5 shows a schematic representation of regulating and control unit 10 for correcting the XYZ drift caused by temperature changes. One or more temperature sensors 30₁, 30₂ . . . 30_{N} are connected with regulating and control unit 10. The signals from said temperature sensors are transmitted to regulating and control unit 10 to obtain therefrom the signals for operating the first, second and third motor 21, 22, 23. Microscope stage 18 is thus adjusted by the regulating and control unit 10 so that the specimen being examined is always in focus and in the same position below objective 16. Regulating and control unit 10 is provided with an interface 46 whereby the data can be entered or the data can be transferred to computer 4. Interface 46 can be, for example, an RS 232 interface, an USB interface or a wireless connection.

FIG. 6 shows in principle the structure of firmware 50 for correcting XYZ drift caused by temperature changes. While the microscope is being used, the algorithm contained in firmware 50 constantly corrects the XYZ deviations caused by temperature changes. To this end, firmware 50 makes use of correction table 44 stored in data storage device 9 of regulating and control unit 10. Correction table 44 is retained even after microscope 2 has been turned off and is reused next time the microscope is operated. It is left to the operator to put together a new correction table 44 and to enter said table into data storage device 9 of regulating and control unit 10. During operation, firmware 50 receives from temperature sensors 30₁, 30₂ . . . 30_{N} data from which firmware 50 then determines the temperature changes. The algorithm implemented in firmware 50 in cooperation with correction table 44 determines the settings for the first, second and third motor 21, 22 and 23 that are needed for correcting the XYZ drift caused by temperature changes. The settings on the first, second and third motor 21, 22 and 23 are selected so that they correct the ΔX, ΔY and ΔZ values caused by temperature fluctuations. In this manner, a specimen or a certain region of the specimen is always disposed unchanged relative to optical axis 13 of objective 15 in the work position regardless of temperature changes. Excursions of the specimen are thus prevented even during long-term examinations.

It is also conceivable for the correction table to be established at the factory and during assembly of the microscope be entered into a data storage device of regulating and control unit 10 of microscope 2. At the factory, the correction table is established on the basis of a statistical evaluation of the temperature properties of several microscopes.

1. A microscope (2) with a stand (12) and a microscope stage (18) disposed on the stand (12) and capable of being moved in all three space directions (X, Y, and Z) by means of motors comprising:
at least one temperature sensor (30) in or on said stand (12);
a regulating and control unit (10), said regulating and control unit including a data storage device (9) and a microprocessor (11);
a correction table (44) stored in said data storage device (9) and containing drift values for the three space directions (X, Y and Z) of said stand (12) as a function of temperature; and,
first, second, and third motors (21, 22, 23) on said microscope stage (18);
wherein said temperature sensors (30) are connected to said microprocessor and provide signals on the basis of which it is possible to call up appropriate values for corrections; and,
whereby said regulating and control unit (10) adjusts a said first, second and third motor (21, 22, 23) so that said microscope stage (18) assumes a stable position in space independently of the temperature.

2. The microscope according to claim 1, wherein said correction table (44) can be established manually.

3. The microscope according to claim 1, wherein said correction table (44) can be established automatically.

4. The microscope according to claim 1, wherein said regulating and control unit (10) is integrated into the stand (12) of the microscope (2).

5. The microscope according to claim 1, wherein said the regulating and control unit (10) in the stand (12) is disposed in an external electronics box (42).

6. The microscope according to claim 4 further comprising an input unit (38) which is connected with the regulating and control unit (10).

7. The microscope according to claim 6, characterized in that the input unit (38) is a mouse, a trackball, a key or a touchscreen.

8. A method for correcting XYZ drift caused by temperature changes in a microscope (2) with a stand (12), a microscope stage (18) disposed on the stand (12) and being capable of being moved in all three space directions (X, Y, Z) by first, second, and third motors, and with at least one temperature sensor (30) disposed in or on the stand (12), comprising:
recording and storing a correction table (44) in a data storage device (9) in a regulating and control unit (10) associated with said microscope (2); and,
operating said microscope (2) in the examination mode so that said regulating and control unit (10), on the basis of the signals received from the temperature sensors (30) and of the contents of the correction table (44), operates said first, second and third motors (21, 22, 23) of the microscope stage (18) in a manner such that the position of said stage (18) relative to an optical axis (13) of an objective placed in the work position of said objective is constant with time.

9. The method according to claim 8, wherein said correction table (44) is established manually.

10. The method according to claim 9, further comprising:
providing an ocular having a first cross hairs (34);
placing a slide having a second cross hairs (35) on said microscope stage (18);
focusing said second cross hairs (35) by setting said third motor (23); and
setting said first and/or second motor (21, 22) to superimpose said first cross hair and said second cross hair; and,
actuating said input device (38) to transfer data required for displacement to superimpose said first cross hairs and said second cross hairs of said ocular and said second slide to said correction table (44).

11. The method according to claim 10, wherein said input device (38) is a mouse, a trackball, a key or a touchscreen.

12. The method according to claim 8, wherein said correction table (44) is established automatically.

13. The method according to claim 12, further comprising
focusing an autofocus of a camera (25) on the said second cross hairs (35);
displacing said second cross hairs (35) into said optical axis (13) of the objective (16) using an image-processing software in cooperation with said first and second; motors (21, 22); and
transferring the data needed for the displacement to the correction table (44) available in the data storage device (9).
wherein only said second cross hairs (35) is provided on said slide.

14. The method according to claim 8, wherein said regulating and control unit (10) is integrated into said stand (12) of said microscope (2).

15. The method according to claim 8, wherein said regulating and control unit (10) in said stand (12) is disposed in an external electronics box.

16. The method according to claim 8, further comprising:
establishing said correction table on the basis of a statistical evaluation of several stands; and,
incorporating said correction table in the regulating and control unit (10) of said microscope.

17. The microscope according to claim 5 further comprising an input unit (38) which is connected with the regulating and control unit (10).

18. The microscope according to claim 17, characterized in that the input unit (38) is a mouse, a trackball, a key or a touchscreen.
